(19) United States
(12) Patent Application Publication
(10) Pub. No.: US 2011/0130045 A1
(43) Pub. Date: Jun. 2, 2011

(54) ELECTRICAL CONNECTOR ASSEMBLY AND METHOD FOR MAKING THE SAME

(75) Inventors: PING-SHENG SU, Tu-Cheng (TW); XIAO-LI LI, Kunshan (CN)

(73) Assignee: HON HAI PRECISION INDUSTRY CO., LTD., Tu-Cheng (TW)

(21) Appl. No.: 12/957,426

(22) Filed: Dec. 1, 2010

(30) Foreign Application Priority Data
Dec. 1, 2009 (CN) 200910310718.X
Dec. 1, 2009 (CN) 200910310719.4
Dec. 1, 2009 (CN) 200920316273.1
Dec. 1, 2009 (CN) 200920316283.5

(51) Int. Cl. H01R 24/00; H01R 43/00

(52) U.S. Cl. 439/660; 29/884

(57) ABSTRACT

An electrical connector assembly (100) includes a metal shell (3), an insulative housing (1), a number of terminals (2) retained in the insulative housing and a cable (5). The cable includes a set of metal wires (55) and a set of insulative layers (54) respectively covering around the metal wires. The terminals includes a number of contact portions (21) and a number of tail portions (22) for connecting to the cable, each of the tail portions forms an abutting portion (222) for abutting against the metal wires electrically and mechanically.

### FIELD OF THE INVENTION

The present invention generally relates to an electrical connector assembly and method for making electrical connector assembly.

### DESCRIPTION OF PRIOR ART

An universal serial bus (USB) connector assembly usually comprises an insulative housing, a plurality of terminals retained in the insulative housing, and a cable connecting with the terminals. The terminals comprise a plurality of tail portions extending out of the insulative housing and soldered with the wires of the cable. The connection between the terminals and the cable needs a soldering process and usually sorts of soldering fluxes are required, which is wasteful to material and as well, induces pollution to the environment. Because wires of the cable are respectively soldered with the corresponding terminals, the soldering process is very time-consuming and troublesome.

Hence, an improved electrical connector assembly is highly desired to overcome the aforementioned problems.

### SUMMARY OF THE INVENTION

Accordingly, an object of the present invention is to provide an electrical connector assembly easily manufactured.

In order to achieve the object set forth, an electrical connector assembly in accordance with the present invention comprises a metal shell, an insulative housing, a number of terminals retained in the insulative housing and a cable. The cable includes a set of metal wires and a set of insulative layers respectively covering around the metal wires. The terminals includes a number of contact portions and a number of tail portions for connecting to the cable, each of the tail portions forms an abutting portion for abutting against the metal wires electrically and mechanically.

A method for making an electrical connector assembly, comprising a plurality of steps of: providing an insulative housing, the insulative housing having a base portion and a tongue portion extending forwardly from the base portion; providing a plurality of terminals and retaining the terminals in the insulative housing, the terminals having contact portions extending along the tongue portion and tail portions extending beyond the base portion of the insulative housing; providing the cable having a set of metal wires contacting with the contacting portions of the terminals and a set of insulative layers formed on the metal wires respectively; providing a metal shell having a main portion covering the insulative housing and a cable retainer at the rear side of the main portion for retaining the cable.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of an electrical connector assembly constructed in the preferred embodiment of the present invention;

FIG. 2 is an exploded, perspective view of the electrical connector assembly;

FIG. 3 is similar to FIG. 2, but taken another aspect;

FIG. 4 is an enlarged view of the encircled part A labeled in FIG. 2; and

FIG. 5 is an enlarged view of the encircled part B labeled in FIG. 2.

### DETAILED DESCRIPTION OF PREFERRED EMBODIMENTS

Reference will now be made in detail to the preferred embodiment of the present invention.

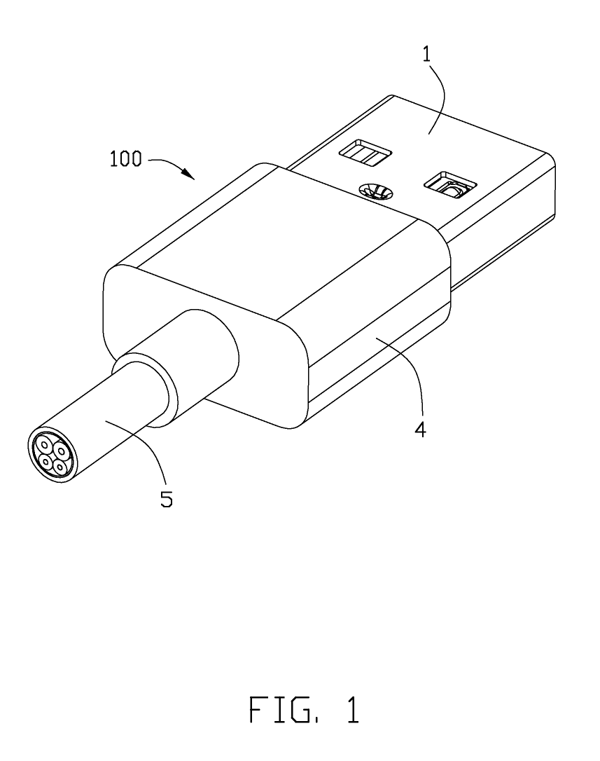

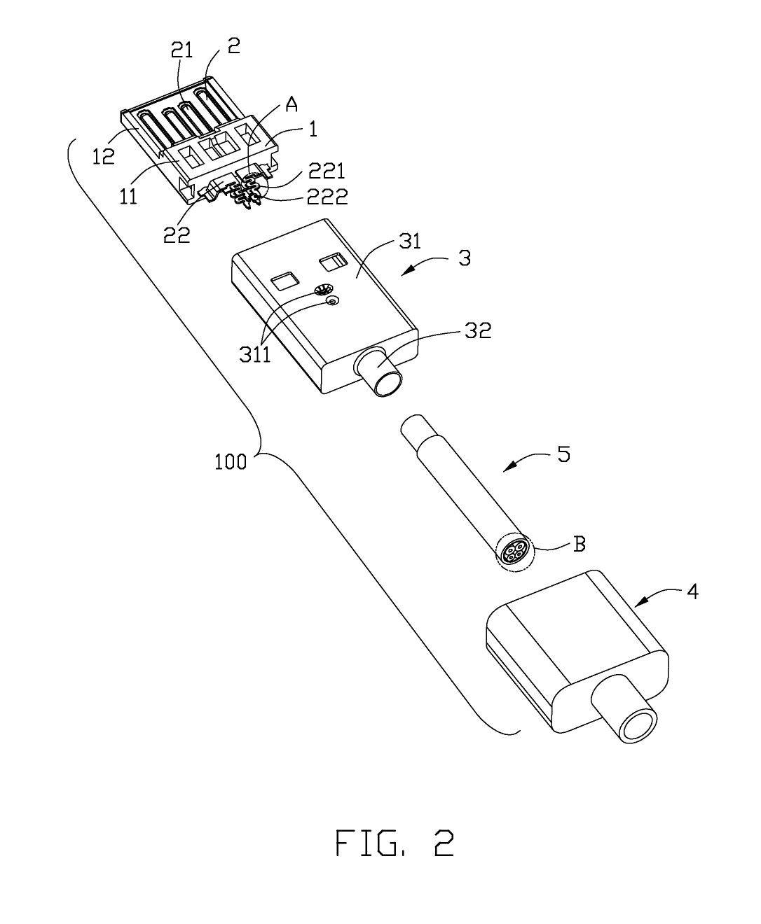

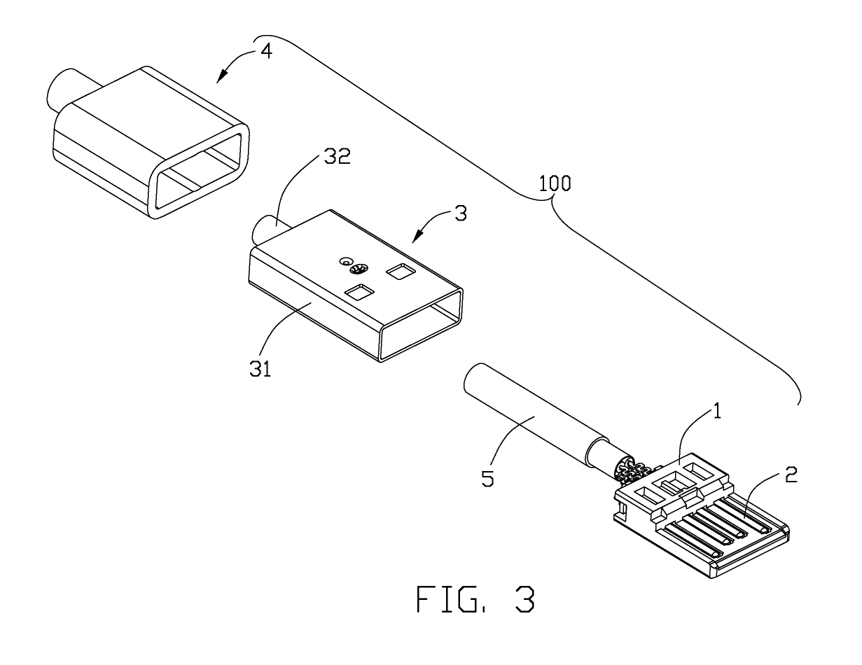

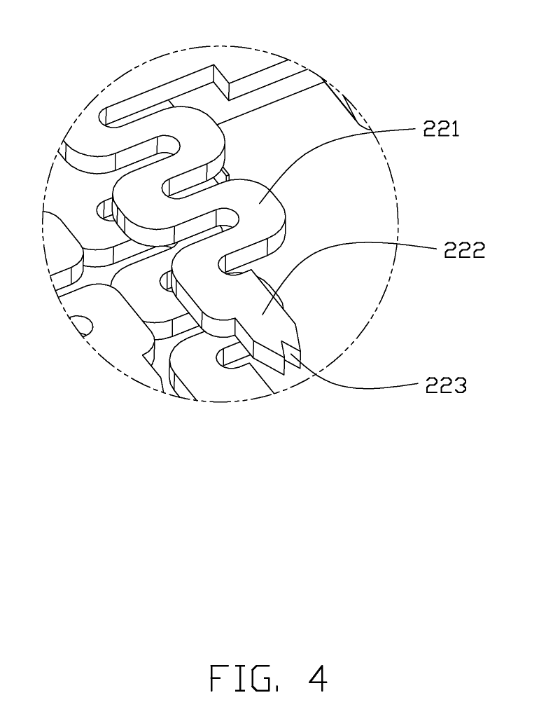

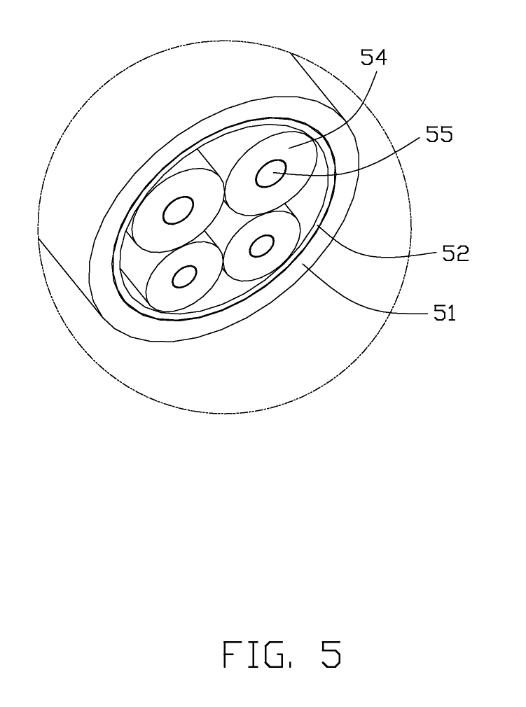

Referring to FIGS. 1-5, an electrical connector assembly 100 in accordance with the present invention comprises an insulative housing 1, a plurality of terminals 2 retained in the insulative housing 1, a metal shell 3 covers on the insulative housing 1, a cable 5 connect to the terminals 2 and a holding portion 4 covers the metal shell 3 for user holding the electrical connector.

The insulative housing 1 includes a base portion 11 and a tongue portion 12 extending forwardly from the base portion 11.

There are contact portions 21 of the terminals 2 extend along the tongue portion 12, and the tail portions 22 extend beyond the base portion 11 of the insulative housing 1, each of the tail portions 22 comprises an S-shape spring portion 221 and an abutting portion 222 with at least two forks 223.

The metal shell 4 comprises a main portion 31 covers on the insulative housing 2 and a cable retainer 32 formed on the rear side of the main portion 31 for retaining the cable 5. And at least a protruding portion 311 protrudes inwardly from the main portion 31 for positioning the insulative housing 1 in right position. The cable retainer 32 has a tear portion (not shown) for tying up the cable 5.

A cable comprises a set of metal wires 55 and a set of insulative layers 54 covered thereon, respectively, a shielding layer 54 shielding on the insulative layers 54, and a protective cover 51 covers on said shielding layer to protect the wires from scratching The number of the wires and the terminals are same. Part of the insulative protective cover 51 removed to expose the shielding layer 52, and the tear portion 32 of the metal shell 3 ties on the shielding layer 52.

A method for making the electrical connector assembly comprises steps of:
providing the insulative housing 1, the insulative housing 1 having a base portion 11 and a tongue portion 12 extending forwardly from the base portion 11;
providing the terminals 2 and retaining the terminals 2 in the insulative housing 1, the terminals 2 having contact portions 21 extend along the tongue portion 12 and the tail portions 22 extend beyond the base portion 11 of the insulative housing 1, each of the tail portions 22 comprising an S-shape spring portion 221 and an abutting portion 222 with forks 223;
providing the cable 5 having a set of metal wires 55 and a set of insulative layers formed on the metal wires 55 respectively, the shielding layer 52 and the insulative protective cover 51 covers on the wires from interior to exterior;
providing the metal shell 3 having a main portion 31 to cover the insulative housing 1 and the terminals 2 and a cable retainer 32 formed with a tear portion on the rear side of the main portion 31 for retaining the cable 5, the metal shell 3 having at least a protruding portion 311 protrudes inwardly from the metal shell 3 for positioning the insulative housing 1 and the cable 5 tied by the tear portion to mate the wires 55 with the forks 223 of the abutting portion 222 respectively.
The spring portions 221 supply the mating force between the terminals 2 and the cable 5, and makes the spring portions 221 mating with the metal wires 55 steady with different distortion. The forks 223 formed on the end of each tail portion 22 abut against the metal wires 55 to make electrical and mechanical connection, and two or more forks 223 could make the connection much more reliable.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. An electrical connector assembly, comprising:
an insulative housing having a base portion and a tongue portion extending forwardly from the base portion;
a cable comprising a set of metal wires and a set of insulative layers respectively covering around the metal wires, a shielding layer shielding over the insulative layers, and a protective cover covering on said shielding layer; and
a plurality of terminals retained in the insulative housing, having a plurality of contact portions extend along the tongue portion for mating with mating connector and a plurality of tail portions extending beyond the base portion, each of the tail portions forming an abutting portion for abutting against the metal wires electrically and mechanically.

2. The electrical connector assembly as recited in claim 1, wherein each one of the tail portion has an S-shape spring portion and the abutting portion integrally extends from the spring portion.

3. The electrical connector assembly as recited in claim 2, wherein the abutting portion has at least two forks at a free end thereof.

4. The electrical connector assembly as recited in claim 1, further comprising a metal shell covering the insulative housing, and wherein the metal shell has a protruding portion protruding inwardly for positioning the insulative housing therein.

5. The electrical connector assembly as recited in claim 1, further comprising a metal shell covering the insulative housing, and wherein the metal shell forms a cable retainer and the protective cover is removed at a front end thereof, thus the frontal shielding layer is inserted into in the cable retainer.

6. The electrical connector assembly as recited in claim 5, wherein the cable retainer forms a tear portion for tying the cable and connecting the shielding layer.

7. A method for making an electrical connector assembly, comprising a plurality of steps of:
providing an insulative housing, the insulative housing having a base portion and a tongue portion extending forwardly from the base portion;
providing a plurality of terminals and retaining the terminals in the insulative housing, the terminals having contact portions extending along the tongue portion and tail portions extending beyond the base portion of the insulative housing;
providing the cable having a set of metal wires contacting with the contacting portions of the terminals and a set of insulative layers formed on the metal wires respectively;
providing a metal shell having a main portion covering the insulative housing and a cable retainer at the rear side of the main portion for retaining the cable.

8. The method for making the electrical connector assembly as claimed in claim 7, wherein each of the tail portions comprises an S-shape spring portion and an abutting portion abutting against the wires.

9. The method for making the electrical connector assembly as claimed in claim 8, wherein the abutting portion forms at least two forks at the free end thereof.

10. The method for making the electrical connector assembly as claimed in claim 9, wherein the cable retainer forms a tear portion for tying the cable to mate the wires with the forks of the abutting portion respectively.

11. The method for making the electrical connector assembly as claimed in claim 10, further comprising a shielding layer covering on the wires and an insulative protective cover covering the shielding layer, wherein part of the insulative protective cover received in the tear portion of the metal shell has being removed.

12. The method for making the electrical connector assembly as claimed in claim 7, wherein the main portion of the metal shell has at least a protruding portion protruded inwardly for positioning the insulative housing.

13. An electrical cable connector assembly comprising:
an insulative housing defining a front mating port and a rear mounting port;
a plurality of contacts disposed in the housing, each of said contacts defining a front contacting section exposed in the mating port, and rear connecting section exposed in the mounting port; and
a cable including a plurality of wires connecting to the rear mounting port; wherein
the connecting section includes a fork like end linked to a spring portion connected to the corresponding wire in an axial direction along which said spring portion is resiliently deformable.
